(19) United States
(12) Patent Application Publication
(10) Pub. No.: US 2006/0216590 A1
(43) Pub. Date: Sep. 28, 2006

(54) End cover structure of prismatic battery

(76) Inventors: Jinn-Lung Wang, Taoyuan Hsien (TW); Jui-Min Tsai, Tainan Hsien (TW); Hong-Ming Chiu, Tainan Hsien (TW)

Correspondence Address: PRO-TECTOR INTERNATIONAL SERVICES, 20775 NORADA CT., SARATOGA, CA, 95070, US

(21) Appl. No.: 11/092,454

(22) Filed: Mar. 28, 2005

(51) Int. Cl. H01M 2/04

(52) U.S. Cl. 429/175

(57) ABSTRACT

An end cover structure of a prismatic battery is disclosed, comprising a rectangular plate and a rivet head. The rectangular plate has a first surface and a second surface opposite to the first surface, and the second surface is a plane. The rivet head is located on the first surface of the rectangular plate and separates the first surface into a first planar area and a second planar area. The height of the first planar area is lower than that of the second planar area, and the first planar area and the second planar area are adjacent to the rivet head.

### FIELD OF THE INVENTION

The present invention relates to an end cover structure of a prismatic battery, and more particularly, to an end cover structure of a prismatic lithium-ion battery.

### BACKGROUND OF THE INVENTION

With the tendency of current portable electronic products to be lightweight and thin and have small-footprint designs coupled with the requirement for longer usage time between battery charges, secondary batteries that are small and lightweight and have a high energy density have become essential parts of portable electronic products.

In the secondary batteries, lithium-ion batteries have extensively been applied in the portable electronic products, such as notebooks, personal digital assistants (PDA) and mobile phones, because the lithium-ion batteries are characterized as being lightweight and having high working voltage, high energy density and high longevities, and they can also meet the small-size requirement of portable electronic products.

Presently, safety designs of lithium-ion battery end cover structures mainly include using safety valves and using conductive pieces set under end cover plates. The safety valve design employs a valve method to release pressure so as to prevent batteries from bursting when the pressure within the batteries increases abnormally. However, the safety valve design cannot provide batteries protection from being crushed. The design of setting a conductive piece under the end cover plate is done to make the conductive piece contact cans of the batteries to form external short circuits so as to prevent the batteries from bursting as a result of being superheated while being squelched laterally, namely Y crush.

### SUMMARY OF THE INVENTION

Therefore, one objective of the present invention is to provide an end cover structure of a prismatic battery, such that an external short circuit can be formed when the battery is deformed laterally by modifying the structural design of the end cover structure, so that an additional conductive piece set under the end cover is unnecessary and the process can thereby be simplified as compared to conventional designs.

Another objective of the present invention is to provide an end cover structure of a prismatic battery, wherein a rivet head is used as a separator, and a plate structure on one side of the end cover is thinner and therefore structurally weaker than that on the other side of the end cover. When the prismatic battery undergoes Y crush, the thinner end cover is deformed outwardly such that it contacts the rivet head. Accordingly, a path of an external short circuit can be formed when the prismatic battery is deformed, so that the safety of the battery can be enhanced.

Still another objective of the present invention is to provide an end cover structure of a prismatic battery such that a bottom side of the end cover comprises a transversely located V-shaped trench passing through a short axle of the end cover. The structural strength of the end cover at the V-shaped trench is weaker than at other locations, so when the prismatic battery suffers Y crush, the end cover at the V-shaped trench is deformed first and causes the end cover to contact the rivet head so as to form a path of an external short circuit. Therefore, danger is lowered when the battery is deformed.

Yet another objective of the present invention is to provide an end cover structure of a prismatic lithium-ion battery. In the end cover structure, there is a gap between a short sidewall of a rivet head and a planar area of a rectangular plate. Thus, when the end cover is deformed outwardly, the probability of the rectangular plate contacting the rivet head can be effectively increased.

According to the aforementioned objectives, the present invention further provides an end cover structure of a prismatic battery comprising: a rectangular plate having a first surface and a second surface opposite to the first surface, wherein the second surface is a plane; and a rivet head located on the first surface of the rectangular plate to separate the first surface into a first planar area and a second planar area, wherein the height of the first planar area is lower than that of the second planar area, and the first planar area and the second planar area are adjacent to the rivet head.

According to a preferred embodiment of the present invention, the rectangular plate further comprises a V-shaped trench transversely located on the second surface of the rectangular plate and passing through a short axle of the second surface.

The thickness of the first planar area and the second planar area respectively located at two sides of the rivet head is different, so the structure of the first planar area is weaker. In addition, the second surface of the rectangular plate has a V-shaped trench passing through the short axle of the second surface. Therefore, when the prismatic battery undergoes Y crush, the rectangular plate can deform to contact the rivet head in order to form an external short circuit, thereby achieving the objective of enhancing the safety of the battery.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a top view of an end cover structure of a prismatic battery in accordance with a preferred embodiment of the present invention.

FIG. 2 illustrates a bottom view of an end cover structure of a prismatic battery in accordance with a preferred embodiment of the present invention.

FIG. 3 illustrates a cross-sectional view of the end cover structure of the prismatic battery along the cross-sectional line I-I shown in FIG. 1.

FIG. 4 illustrates a cross-sectional view of the end cover structure of the prismatic battery after a Y crush test.

FIG. 5 illustrates a top view of an end cover structure of a prismatic battery in accordance with another preferred embodiment of the present invention.

### DETAILED DESCRIPTION OF THE PREFERRED EMBODIMENT

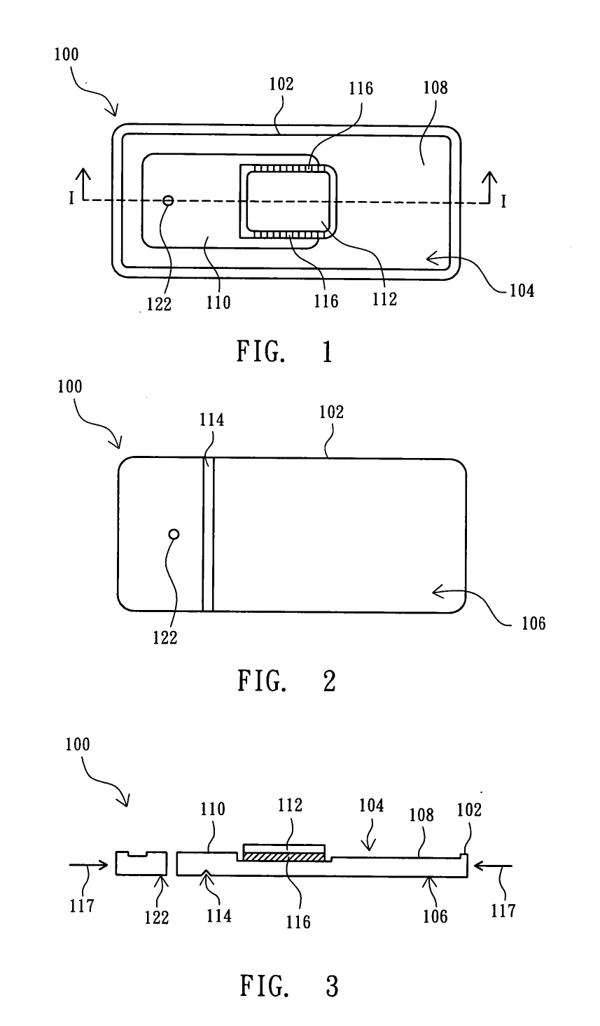

The present invention discloses an end cover structure of a prismatic battery, which can enhance the safety of the battery. In order to make the illustration of the present invention more explicit and complete, the following description is stated with reference to FIGS. 1-5.

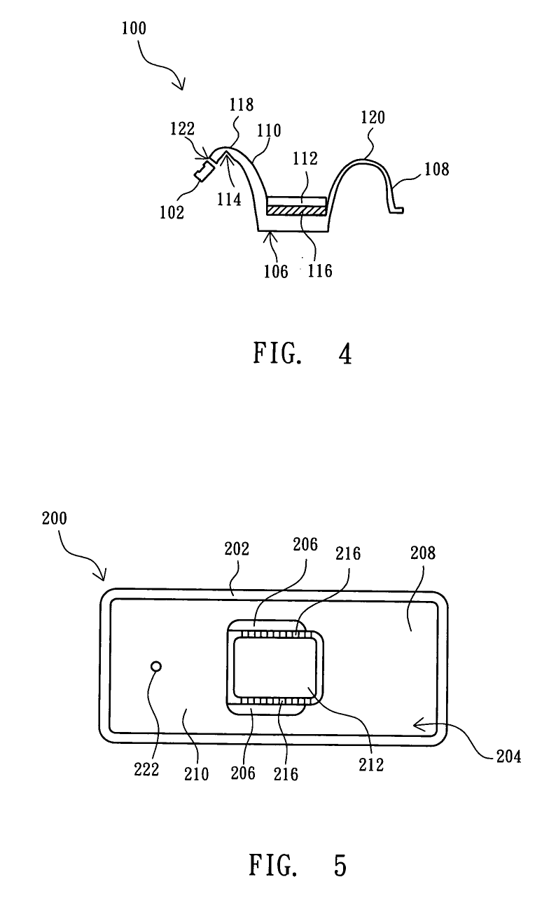

Referring to FIG. 1, FIG. 1 illustrates a top view of an end cover structure of a prismatic battery in accordance with a preferred embodiment of the present invention. The end cover structure 100 of the prismatic battery comprises a rectangular plate 102 and a rivet head 112, wherein the rivet head 112 is located on a surface 104 of the rectangular plate 102, and the rivet head 112 and the rectangular plate 102 form electrodes of different polarities to respectively carry charges of different polarities. In a preferred embodiment of the present invention, the prismatic battery can be, for example, a lithium-ion battery, the material of the rectangular plate 102 can be, for example, aluminum, the rivet head 112 is of negative polarity, and the rectangular plate 102 is of positive polarity. The rivet head 112 is preferably located on the central area of the surface 104 of the rectangular plate 102 to separate the surface 104 of the rectangular plate 102 into two sides, wherein one side of the rectangular plate 102 is a planar area 108, and the other side of the rectangular plate 102 is a planar area 110. The planar area 108 and the planar area 110 are adjacent to the rivet head 112, and the planar area 110 preferably surrounds three sides of the rivet head 112 while the planar area 108 is adjacent to the remaining side of the rivet head 112. Thus, the rivet head 112 and the planar area 110 are located on the same side of the rectangular plate 102. The height of the planar area 108 is lower than that of the planar area 110. As illustrated in FIG. 3, there is an isolated layer 116 between the rivet head 112 and the rectangular plate 102 to isolate the rivet head 112 from the rectangular plate 102. The isolated layer 116 can extend to the space between a long sidewall of the rivet head 112 and the planar area 110, and a short sidewall of the rectangular plate 102 and the planar area 108 as well as the planar area 110 are separated by a gap that is completely absent of the isolated layer. However, it is worthy to note that the isolated layer 116 can also extend to the space between the short sidewall of the rivet head 112 and the planar area 108 as well as the planar area 110 of the rectangular plate 102, as long as there is a gap in the space between the short sidewall of the rivet head 112 and the planar area 108 as well as the planar area 110 of the rectangular plate 102. The rectangular plate 102 further includes an injection hole 122 for injecting electrolyte into the battery.

One feature of the present invention is that there is a gap between the short sidewall of the rivet head 112 and the planar area 108 as well as the planar area 110 of the rectangular plate 102. Therefore, when the end cover structure 100 is squelched and deformed, the structure can ensure that the rectangular plate 102 in the planar area 108 contacts the rivet head 112.

Referring to FIG. 2, FIG. 2 illustrates a bottom view of an end cover structure of a prismatic battery in accordance with a preferred embodiment of the present invention. The rectangular plate 102 further includes a surface 106 opposite to the surface 104, wherein the surface 106 is a plane. In a preferred embodiment of the present invention, the surface 106 of the rectangular plate 102 further includes a trench 114 passing through a short axle of the surface 106. The trench 114 is preferably V-shaped and does not pass under the rivet head 112. The trench 114 is preferably located on the surface 106 opposite to the planar area 110. However, it is worthy to note that the trench 114 also can be located on the surface 106 opposite to the planar area 108.

Referring to FIG. 3, FIG. 3 illustrates a cross-sectional view of the end cover structure of the prismatic battery along the cross-sectional line I-I shown in FIG. 1. The planar area 110 is higher than the planar area 108, and the surface 106 is planar, so the thickness of the rectangular plate 102 in the planar area 110 is larger than that of the rectangular plate 102 in the planar area 108. Therefore, the structural strength of the planar area 108 is smaller than that of the planar area 110, and the intersection of the planar area 108 with the planar area 110 forms a structurally weak line. The isolated layer 116 is located between the rivet head 112 and the surface 104 of the rectangular plate 102 in order to electrically isolate the rectangular plate 102 from the rivet head 112. In a preferable embodiment of the present invention, the trench 114 is located on the surface 106 opposite to the planar area 110, and the thickness of the rectangular plate 102 at the trench 114 is less than that of the surrounding rectangular plate 102. Therefore, the structural strength at the trench 114 is lowered to form another structurally weak line.

Referring FIG. 4, FIG. 4 illustrates a cross-sectional view of the end cover structure of the prismatic battery after a Y crush test. The structural strength of the planar area 108 is lower than that of the planar area 110, so when the lateral side of the battery is under a pressure in a direction 117 (namely Y crush), such as shown in FIG. 3, the rectangular plate 102 in the planar area 108 is deformed so as to form a curve 120 on the planar area 108. In addition, a gap exists between the short sidewall of the rivet head 112 and the planar area 108 as well as the planar area 110, thus allowing the rectangular plate 102 in the planar area 108 to contact the rivet head 112. Furthermore, the structural strength of the rectangular plate 102 at the trench 114 is smaller than that of the rectangular plate 102 around the trench 114, so when the lateral side of the battery is under a pressure in a direction 117, the rectangular plate 102 at the trench 114 is deformed first to form a curve 118, making the rectangular plate 102 in the planar area 110 contact the rivet head 112. When the rectangular plate 102 in the planar area 108 and the planar area 110 contact the rivet head 112, short circuits between the positive polarity and the negative polarity are formed outside the battery. Therefore, when the battery is laterally deformed by external forces, an external short circuit can first occur on the end cover structure 100, preventing the temperature from being increased and causing an explosion by an internal short circuit in the battery.

Moreover, when the battery is deformed under a lateral pressure, the rectangular plate 102 of the end cover structure 100 and the rivet head 112 form a short circuit between the positive polarity and the negative polarity, thereby lowering the short circuit resistance and distributing the short circuit current over the entire rectangular plate 102. Therefore, high localized heating is prevented.

Referring to FIG. 5, FIG. 5 illustrates a top view of an end cover structure of a prismatic battery in accordance with another preferred embodiment of the present invention. The end cover structure 200 comprises a rectangular plate 202 and a rivet head 212, wherein the rivet head 212 is located on a surface 204 of the rectangular plate 202, and the rivet head 212 and the rectangular plate 202 form electrodes of different polarities to respectively carry charges of different polarities. In a preferred embodiment of the present invention, the prismatic battery can be, for example, a lithium-ion battery, the material of the rectangular plate 202 can be, for example, aluminum, the rivet head 212 is of negative polarity, and the rectangular plate 202 is of positive polarity. The rivet head 212 is preferably located on the central area of the surface 204 of the rectangular plate 202. Outside the rivet head 212, the surface 204 of the rectangular plate 202 is divided into two planar areas 206, a planar area 208 and a planar area 210. The planar area 208 and the planar area 210 are respectively located on the two long axles of the rectangular plate 202, and the planar areas 206 are located on the short axles of the rectangular plate 202. The planar areas 206, the planar area 208 and the planar area 210 are respectively adjacent to the four sides of the rivet head 212. The height of the planar area 208 is the same as that of the planar area 210, and the height of the planar areas 206 are higher than those of the planar area 208 and the planar area 210. There is further an isolated layer 216 between the rivet head 212 and the rectangular plate 202 to isolate the rivet head 212 from the rectangular plate 202. The isolated layer 216 can extend to the space between a sidewall of the rivet head 212 and the planar areas 206. The rectangular plate 202 further includes an injection hole 222 for injecting electrolyte into the battery. In the preferred embodiment of the present invention, the opposite surface of the rectangular plate 202 is planar.

The planar areas 206 are higher than the planar area 210 and the planar area 208, and the opposite surface of the rectangular plate 202 is planar, so the thickness of the rectangular plate 202 in the planar areas 206 is larger than that of the rectangular plate 202 in the planar area 210 and the planar area 208. Therefore, the structural strengths of the planar area 210 and the planar area 208 are smaller than those of the planar areas 206, and the intersections between the planar area 208 as well as the planar area 210 with the planar areas 206 form structurally weak lines.

The structural strengths of the planar area 210 and the planar area 208 are less than those of the planar areas 206, so when the lateral side of the battery is under a pressure in a Y crush direction, the rectangular plate 202 in the planar area 208 and the planar area 210 is deformed outwardly to make the rectangular plate 202 in the planar area 208 and the planar area 210 contact the rivet head 212.

Therefore, according to the aforementioned description, one advantage of the present invention is that when the battery is compressed by an external force, an external short circuit can be formed by the rectangular plate contacting the rivet head, thereby enhancing the safety of the battery. This advantage is achieved because the thickness of the rectangular plate at two sides of the rivet head are different, the second surface of the rectangular plate has a V-shaped trench passing through the short axle of the second surface, and the structure at one side of the end cover structure is weaker than at the other side.

According to the aforementioned description, the other advantage of the present invention is that the probability of the rectangular plate contacting the rivet head can be effectively increased when the end cover is deformed outwardly by employing a gap between the short sidewall of the rivet head and the planar areas of the rectangular plate.

According to the aforementioned description, still another advantage of the present invention is that when the battery is deformed under a lateral pressure, the rectangular plate of the end cover structure and the rivet head form a short circuit between the positive polarity and the negative polarity, so that the short circuit current is distributed over the entire rectangular plate, preventing high localized heating and thereby avoiding the danger caused by the battery deformation.

As is understood by a person skilled in the art, the foregoing preferred embodiments of the present invention are illustrative of the present invention rather than limiting of the present invention. They are intended to cover various modifications and similar arrangements included within the spirit and scope of the appended claims, the scope of which should be accorded the broadest interpretation so as to encompass all such modifications and similar structure.

What is claimed is:

1. An end cover structure of a prismatic battery, comprising:
a rectangular plate having a first surface and a second surface opposite to the first surface, wherein the second surface is a plane; and
a rivet head located on the first surface of the rectangular plate to separate the first surface into a first planar area and a second planar area, wherein the height of the first planar area is lower than the height of the second planar area, and the first planar area and the second planar area are adjacent to the rivet head.

2. The end cover structure of the prismatic battery according to claim 1, wherein the prismatic battery is a lithium-ion battery.

3. The end cover structure of the prismatic battery according to claim 1, wherein a material of the rectangular plate is aluminum.

4. The end cover structure of the prismatic battery according to claim 1, wherein the rectangular plate further comprises a V-shaped trench located on the second surface and passing through a short axle of the second surface.

5. The end cover structure of the prismatic battery according to claim 4, wherein the V-shaped trench is located on the second surface opposite to the second planar area.

6. The end cover structure of the prismatic battery according to claim 4, wherein the V-shaped trench is located on the second surface opposite to the first planar area.

7. The end cover structure of the prismatic battery according to claim 1, further comprising an isolated layer between the rivet head and the first surface of the rectangular plate.

8. An end cover structure of a prismatic battery, comprising:
a rectangular plate having a first surface and a second surface opposite to the first surface, wherein the rectangular plate comprises a V-shaped trench located on the second surface and passing through a short axle of the second surface; and
a rivet head located on the first surface of the rectangular plate such that the V-shaped trench does not pass under the rivet head.

9. The end cover structure of the prismatic battery according to claim 8, wherein the prismatic battery is a lithium-ion battery.

10. The end cover structure of the prismatic battery according to claim 8, wherein the second surface is a plane.

11. The end cover structure of the prismatic battery according to claim 10, wherein the first surface of the rectangular plate has a first planar area and a second planar area separated by the rivet head, and the height of the first planar area is lower than the height of the second planar area.

12. The end cover structure of the prismatic battery according to claim 11, wherein the first planar area and the second planar area are adjacent to the rivet head.

13. The end cover structure of the prismatic battery according to claim 11, wherein the V-shaped trench is located on the second surface opposite to the second planar area.

14. The end cover structure of the prismatic battery according to claim 11, wherein the V-shaped trench is located on the second surface opposite to the first planar area.

15. The end cover structure of the prismatic battery according to claim 8, further comprising an isolated layer between the rivet head and the first surface of the rectangular plate.

16. An end cover structure of a prismatic battery, comprising:
a rectangular plate having a first surface and a second surface opposite to the first surface, wherein the second surface is a plane, and the rectangular-plate comprises a V-shaped trench located on the second surface and passing through a short axle of the second surface; and
a rivet head located on the first surface of the rectangular plate to separate the first surface into a first planar area and a second planar area, wherein the height of the first planar area is lower than the height of the second planar area, the first planar area and the second planar area are adjacent to the rivet head, and the V-shaped trench does not pass under the rivet head.

17. The end cover structure of the prismatic battery according to claim 16, wherein the prismatic battery is a lithium-ion battery.

18. The end cover structure of the prismatic battery according to claim 16, further comprising an isolated layer between the rivet head and the first surface of the rectangular plate.

19. The end cover structure of the prismatic battery according to claim 16, wherein the V-shaped trench is located on the second surface opposite to the second planar area.

20. The end cover structure of the prismatic battery according to claim 16, wherein the V-shaped trench is located on the second surface opposite to the first planar area.
